(19) United States
(12) Patent Application Publication
(10) Pub. No.: US 2018/0193987 A1
(43) Pub. Date: Jul. 12, 2018

(54) ECCENTRIC ROTARY FASTENING DEVICE

(71) Applicant: KABO TOOL COMPANY, Taichung City (TW)

(72) Inventor: Chih-Ching HSIEH, Taichung City (TW)

(21) Appl. No.: 15/841,258

(22) Filed: Dec. 13, 2017

(30) Foreign Application Priority Data
Jan. 10, 2017 (TW) 106100748

(51) Int. Cl. B25B 23/00; B25B 21/02; B25B 19/00

(52) U.S. Cl. CPC B25B 23/0035; B25B 19/00; B25B 21/02

(57) ABSTRACT

An eccentric rotary fastening device is disposed between a driving tool and a rotated member. The eccentric rotary fastening device includes a rotary seat and at least one impact member. The rotary seat is rotated around a rotational axis. The rotary seat has a driving end and a tightening end. The driving end is detachably connected to the driving tool, and the tightening end is detachably connected to the rotated member. The impact member has a center of gravity and is connected to an exterior of the rotary seat. There is a distance between the center of gravity and the rotational axis.

### RELATED APPLICATIONS

This application claims priority to Taiwan Application Serial Number 106100748, filed Jan. 10, 2017, which is herein incorporated by reference.

### BACKGROUND

### Technical Field

The present disclosure relates to a rotary fastening device. More particularly, the present disclosure relates to an eccentric rotary fastening device.

### Description of Related Art

Hand tool products in recent years toward the development of lightweight, therefore the common rotary fastening tools are necessary to satisfy the market demand for lightweight and compact. For the rotary fastening operations, whether one of screws, nuts or other fastening components is rotated, those fastening operations require a certain amount of a final fastening torque for rotation to ensure the fastening. Familiar rotary fastening tools when fastening devices such as an electric wrench fits sleeve, the electric wrench is limited by an electric motor of the electric wrenches that has a fixed maximum torque. Therefore, the existing electric wrench on the market is difficult to satisfy the miniaturization, light weighting, and maintain better fastening force needs.

On the other hand, although an air impact wrench has a high torque to achieve a higher fastening force of demand, the conventional air impact wrench needs to fit a pump and a pipeline, and the air impact wrench has a large cylinder. Therefore, the volume of the air impact wrench can't be reduced in size. The preceding question of the conventional air impact wrench is also difficult to satisfy the miniaturization, light weighting, and maintain better fastening force needs.

In this respect, one conventional technique has developed a torque control and torque control method of a power tool. The power tool has a motor, a speed gearbox, a driving axis, a percussion unit, and a control system. The percussion unit includes an output axis and a hammer. The speed gearbox is connected to one end of the motor to change the rotation of the motor. The driving axis is connected to the speed gearbox, and the driving axis is rotatable connected to one end of the output axis. The output axis of the power tool can connect to a screwdriver or a socket wrench. The hammer is located at the driving axis, and the hammer can reciprocate displacement along the axis direction of the driving axis. The end of the output axis and the hammer respectively correspond, and the output axis has a hit block and the hammer has another hit block. The two hit blocks can hit each other for generating a tangent impact force when the power tool is locking a screw or a nut.

Aforesaid conventional technology can reach a greater fastening torque of demand, however, its structure has numerous complex elements. Therefore, the power tool can't operate different types of processing machines and operate the hammer or the hit block for quick-release. When the aforesaid conventional technology is operating a rotatable releasing work, the hammer and the hit block will be a waste of the user's physical strength and driving energy. Therefore, aforesaid conventional technology still does not meet the market demand for miniaturization and light weighting.

Further, another conventional technique presented a sleeve which is integrated with a ring member to provide fastening torque. However, the sleeve has a defect that the ring member can't be stripped rapidly even though the mechanism of it has been simplified. Moreover, the ring member of the familiar sleeve is difficult to produce and takes up a lot of space for storage.

Hence, the issue of how to make the rotary fastening tools lightweight, compact and with better fastening force interests the wrench developers and the machine tool manufacturers.

### SUMMARY

According to one aspect of the present disclosure, an eccentric rotary fastening device is disposed between a driving tool and a rotated member. The eccentric rotary fastening device includes a rotary seat and at least one impact member. The rotary seat is rotated around a rotational axis. The rotary seat has a driving end and a tightening end. The driving end is detachably connected to the driving tool, and the tightening end is detachably connected to the rotated member. The impact member has a center of gravity and is connected to an exterior of the rotary seat. There is a distance between the center of gravity and the rotational axis.

According to another aspect of the present disclosure, an eccentric rotary fastening device is disposed between a driving tool and a rotated member. The eccentric rotary fastening device includes a rotary seat and an impact member. The rotary seat is rotated around a rotational axis. The rotary seat has a driving end and a tightening end. The driving end is detachably connected to the driving tool, and the tightening end is detachably connected to the rotated member. The impact member has a center of gravity and is detachably connected to an exterior of the rotary seat. The impact member includes a convex gravity portion which is outwardly extended from the impact member. The convex gravity portion is rotated around the rotational axis by the rotary seat to generate a tangential impact force. The center of gravity is corresponding to the convex gravity portion, and there is a distance between the center of gravity and the rotational axis.

According to further another aspect of the present disclosure, an eccentric rotary fastening device is disposed between a driving tool and a rotated member. The eccentric rotary fastening device includes a rotary seat and a plurality of impact members. The rotary seat is rotated around a rotational axis. The rotary seat has a driving end and a tightening end. The driving end is detachably connected to the driving tool, and the tightening end is detachably connected to the rotated member. The impact members are connected to an exterior of the rotary seat. Each of the impact members has a center of gravity. The centers of gravity of the impact members are integrated to form a combined center of gravity, and there is a distance between the combined center of gravity and the rotational axis.

### BRIEF DESCRIPTION OF THE DRAWINGS

The present disclosure can be more fully understood by reading the following detailed description of the embodiment, with reference made to the accompanying drawings as follows:

FIG. 1 shows an exploded view of an eccentric rotary fastening device according to a first embodiment of the present disclosure;

FIG. 2A shows a schematic view of the eccentric rotary fastening device of FIG. 1;

FIG. 2B shows a cross-sectional view of the eccentric rotary fastening device of FIG. 1;

FIG. 3A shows a schematic view of an eccentric rotary fastening device according to a second embodiment of the present disclosure;

FIG. 3B shows a cross-sectional view of the eccentric rotary fastening device of FIG. 3A;

FIG. 4A shows a schematic view of an eccentric rotary fastening device according to a third embodiment of the present disclosure;

FIG. 4B shows a cross-sectional view of the eccentric rotary fastening device of FIG. 4A;

FIG. 5 shows an exploded view of an eccentric rotary fastening device according to a fourth embodiment of the present disclosure;

FIG. 6 shows an exploded view of an eccentric rotary fastening device according to a fifth embodiment of the present disclosure;

FIG. 7 shows an exploded view of an eccentric rotary fastening device according to a sixth embodiment of the present disclosure;

FIG. 8 shows a schematic view of an operation of the embodiment of FIG. 1; and

FIG. 9 shows a schematic view of the eccentric rotary fastening device having a center of gravity of FIG. 1.

### DETAILED DESCRIPTION

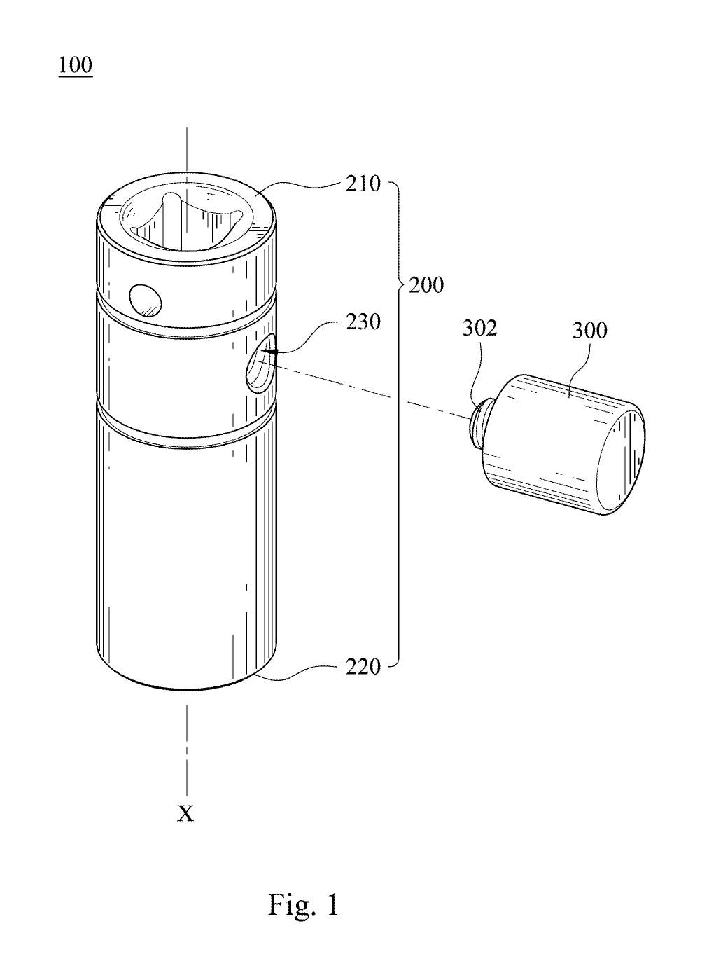

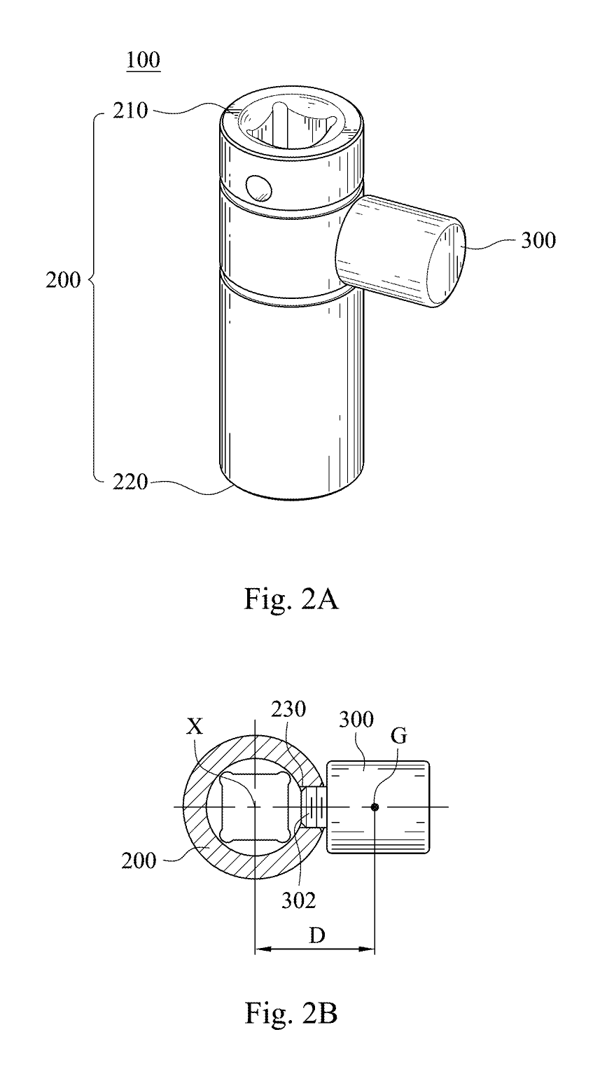

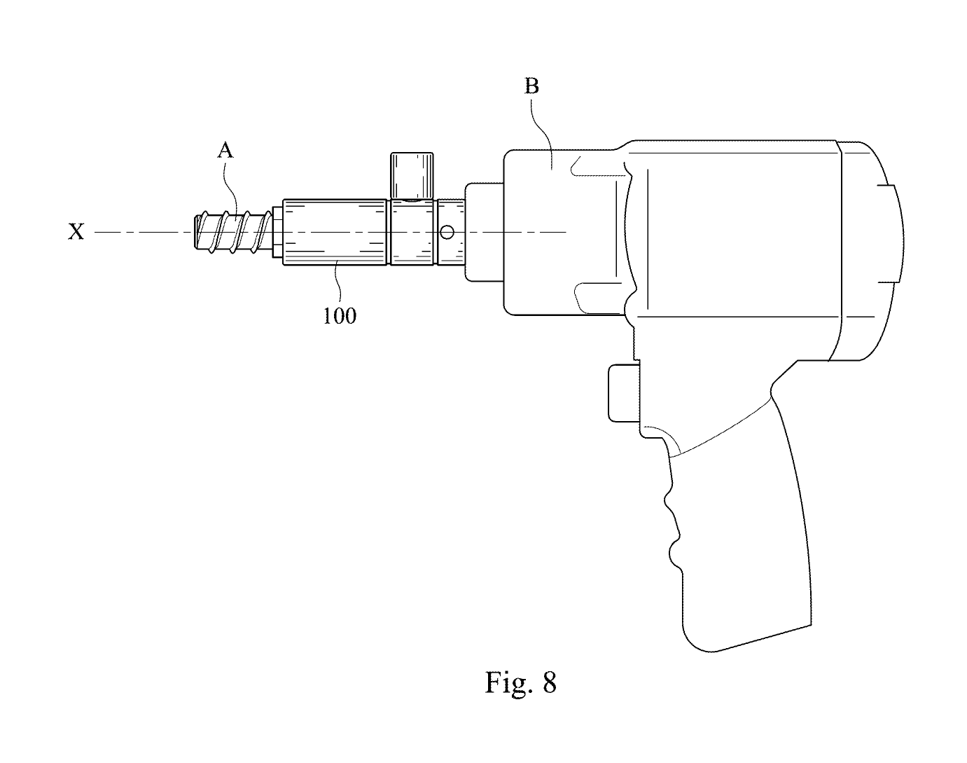

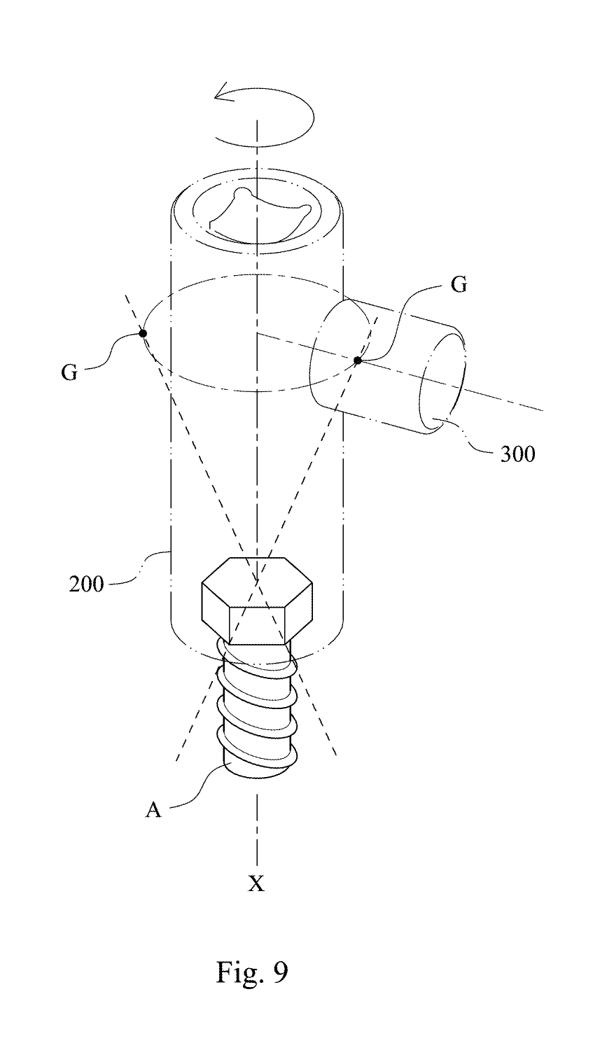

FIG. 1 shows an exploded view of an eccentric rotary fastening device 100 according to a first embodiment of the present disclosure; FIG. 2A shows a schematic view of the eccentric rotary fastening device 100 of FIG. 1; FIG. 2B shows a cross-sectional view of the eccentric rotary fastening device 100 of FIG. 1; FIG. 8 shows a schematic view of an operation of the embodiment of FIG. 1; and FIG. 9 shows a schematic view of the eccentric rotary fastening device having a center of gravity of FIG. 1. The eccentric rotary fastening device 100 is disposed between a rotated member A and a driving tool B. The rotated member A may be a screw, a nut, a lead screw or other screw element. The driving tool B may be an electric wrench or a manually operated wrench. The rotation of the driving tool B can drive the eccentric rotary fastening device 100 to tighten or loosen the rotated member A. The eccentric rotary fastening device 100 includes a rotary seat 200 and an impact member 300.

The rotary seat 200 is rotated around a rotational axis X. The rotary seat 200 has a driving end 210, a tightening end 220 and a concave groove 230. The driving end 210 is detachably connected to the driving tool B, and the tightening end 220 is detachably connected to the rotated member A. The concave groove 230 is adjacent to the driving end 210 and has an internal thread for stably positioning the impact member 300. In addition, the rotary seat 200 is made of metal and has a circular tube shape. The rotary seat 200 has a certain rigidity and can be configured to completely transmit the torque from the driving tool B to the rotated member A.

The impact member 300 has a center of gravity G and is connected to an exterior of the rotary seat 200. There is a distance D between the center of gravity G and the rotational axis X. The distance D is greater than 0. The impact member 300 is made of metal. The impact member 300 can have various shapes and weights for allowing a user to freely operate the eccentric rotary fastening device 100. Moreover, the rotary seat 200 is detachably connected to the impact member 300. The impact member 300 includes a convex portion 302 having an external thread corresponding to the internal thread of the concave groove 230. The external thread of the convex portion 302 is correspondingly screwed into the internal thread of the concave groove 230. Additionally, the distance D and the center of gravity G can be changed according to the impact member 300, and the impact member 300 is determined by the user according to the types of the driving tool B and the rotated member A. Accordingly, the structure of the eccentric rotary fastening device 100 of the present disclosure can provide an extra impact torque by an eccentric rotation and convenient hand carrying or hand-held operation so as to solve the problems of insufficient rotational torque of a conventional rotary fastening device.

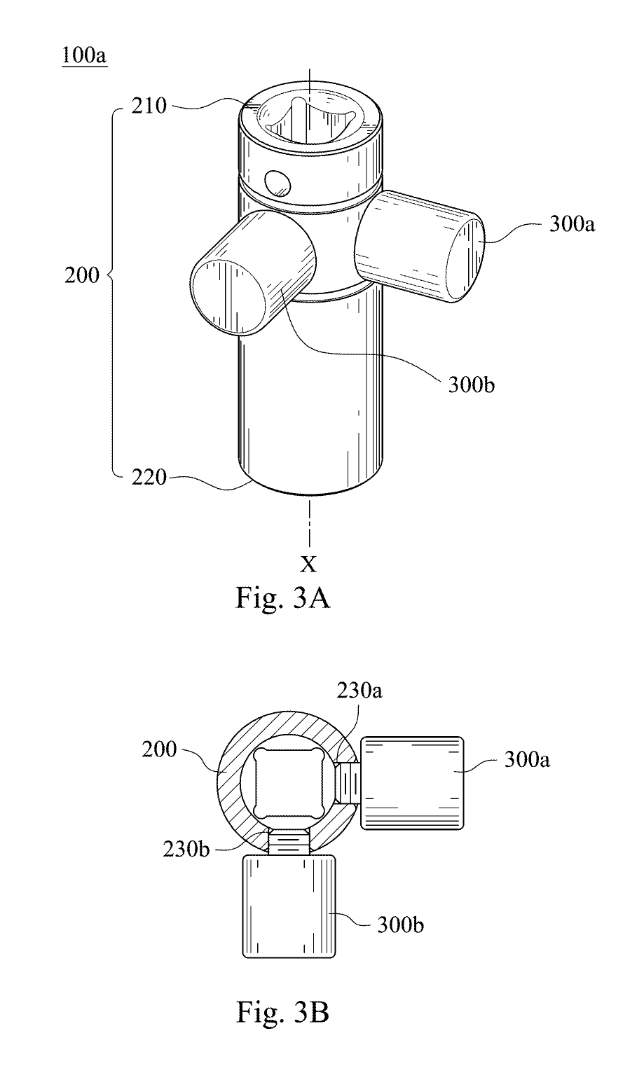

FIG. 3A shows a schematic view of an eccentric rotary fastening device 100a according to a second embodiment of the present disclosure; and FIG. 3B shows a cross-sectional view of the eccentric rotary fastening device 100a of FIG. 3A. The eccentric rotary fastening device 100a is disposed between a rotated member A and a driving tool B. The eccentric rotary fastening device 100a includes a rotary seat 200 and two impact members 300a, 300b.

The rotary seat 200 is rotated around a rotational axis X. The rotary seat 200 has a driving end 210, a tightening end 220 and two concave grooves 230a, 230b. The driving end 210 is detachably connected to the driving tool B, and the tightening end 220 is detachably connected to the rotated member A. The two concave grooves 230a, 230b have the same structure as the concave groove 230 of FIG. 1. The two impact members 300a, 300b have the same structure as the impact member 300. In addition, the two impact members 300a, 300b are connected to an exterior of the rotary seat 200 at different positions. Each of the impact members 300a, 300b has a center of gravity G. The centers of gravity G of the impact members 300a, 300b are integrated to form a combined center of gravity, and there is a distance between the combined center of gravity and the rotational axis X. Certainly, the two impact members 300a, 300b cannot be correspondingly disposed in order to generate the eccentricity effect. In other words, if the two impact members 300a, 300b are the same as each other, an angle between the two impact members 300a, 300b corresponding to the rotational axis X cannot be 180 degrees. Furthermore, the number of the impact members may be greater than 2. The eccentric rotary fastening device 100a of the present disclosure utilizes the two impact members 300a, 300b to provide a broadly diversified selection of rotational torque so as to allow the user to freely determine the rotational torque and the eccentricity effect.

In FIGS. 1-2B, an opening direction of the concave groove 230 is perpendicular to a direction of the rotational axis X. In FIGS. 3A and 3B, an opening direction of each of the concave grooves 230a, 230b is perpendicular to the direction of the rotational axis X. In one embodiment, an angle between the opening direction of the concave groove 230 and the direction of the rotational axis X can be greater than or smaller than 90 degrees. An angle between the opening direction of each of the concave grooves 230a, 230b and the direction of the rotational axis X can be greater than or smaller than 90 degrees, too. In other words, the impact members 300, 300a, 300b can be tilted toward the driving end 210 or the tightening end 220 according to the manufacturer's requirement.

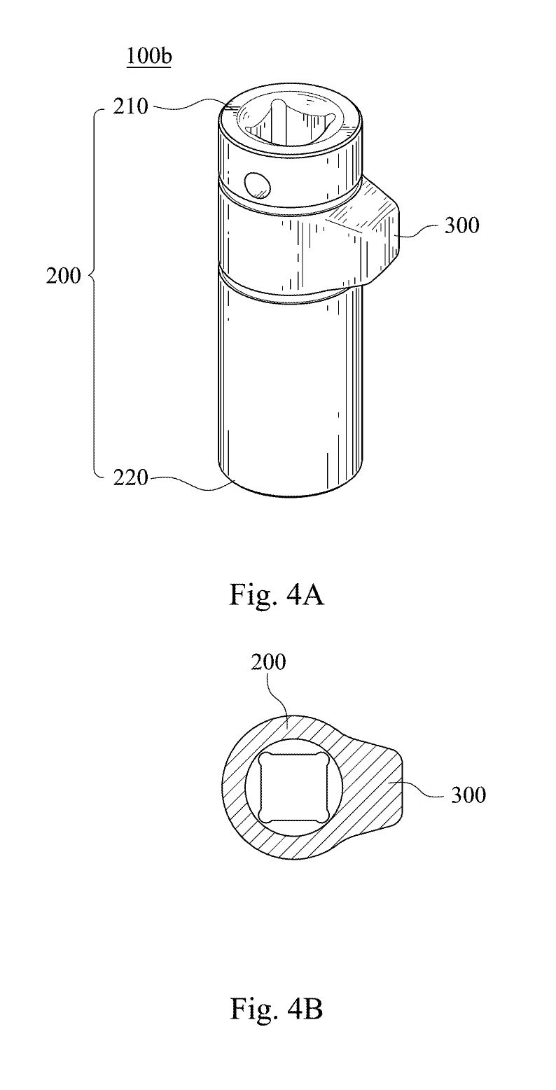

FIG. 4A shows a schematic view of an eccentric rotary fastening device 100b according to a third embodiment of the present disclosure; and FIG. 4B shows a cross-sectional view of the eccentric rotary fastening device 100b of FIG. 4A. In FIGS. 4A and 4B, the eccentric rotary fastening device 100b includes a rotary seat 200 and an impact member 300. The impact member 300 can have a circular shape, a ring shape or an arc shape. The impact member 300 has a trapezoidal shape and an arc shape. The structure of the impact member 300 reduces the air resistance of the rotating so as to effectively and completely transmit the rotational torque. Furthermore, the rotary seat 200 is integrally connected to the impact member 300. The integral connection not only ensures that the rotary seat 200 and the impact member 300 are not separated by vibration or rotation, but also reduces the dangerous instability and the risk of an offset of the center of gravity G and separation.

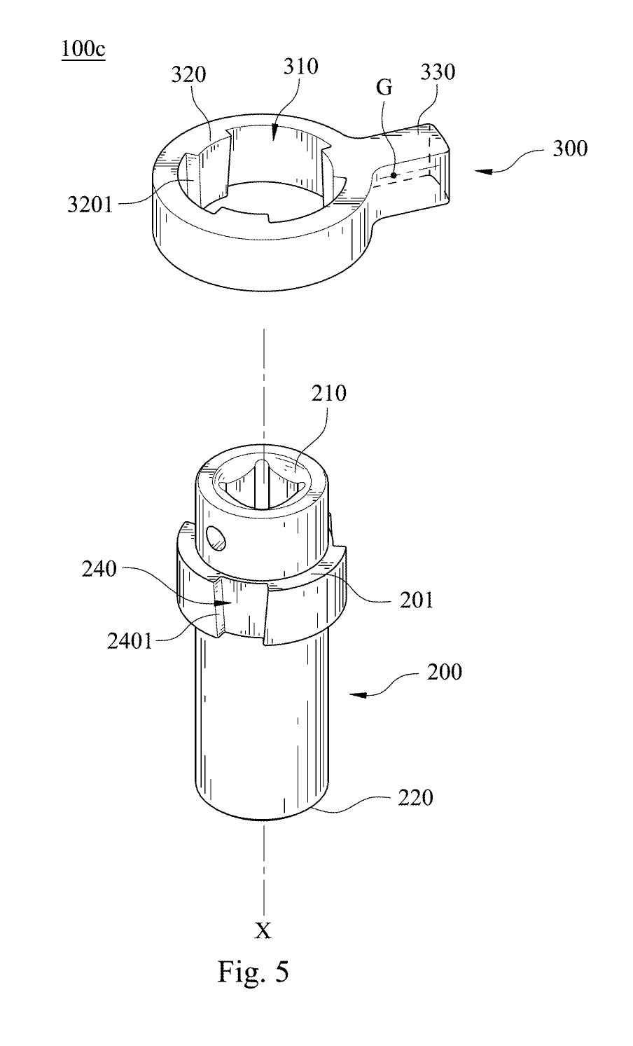

FIG. 5 shows an exploded view of an eccentric rotary fastening device 100c according to a fourth embodiment of the present disclosure. The eccentric rotary fastening device 100c includes a rotary seat 200 and an impact member 300.

The rotary seat 200 is rotated around a rotational axis X. The rotary seat 200 has a driving end 210, a tightening end 220 and three engageable grooves 240. The three engageable grooves 240 are disposed around the rotational axis X. The driving end 210 is detachably connected to the driving tool B, and the tightening end 220 is detachably connected to the rotated member A. The rotary seat 200 has a circular rod shape. The driving end 210 has a square socket for positioning so as to be driven by an electric wrench, an air wrench or a torque wrench. The tightening end 220 is a hex socket for detachably connecting the rotated member A. In addition, the rotary seat 200 includes a bump 201 and the three engageable grooves 240 equidistantly surround the rotational axis X. The three engageable grooves 240 are disposed on the bump 201. Each of the engageable grooves 240 is a trapezoid space that expands outwardly and with two bevels 2401 on both sides.

The impact member 300 has a center of gravity G and is detachably connected to an exterior of the rotary seat 200. In detail, the impact member 300 includes an engageable hole 310, three engageable portions 320 and a convex gravity portion 330. The convex gravity portion 330 is outwardly extended from the impact member 300. The convex gravity portion 330 is rotated around the rotational axis X by the rotary seat 200 to generate a tangential impact force. The center of gravity G is corresponding to the convex gravity portion 330, and there is a distance D between the center of gravity G and the rotational axis X. Moreover, the impact member 300 has a ring shape, and the engageable hole 310 is located at the center of the impact member 300. The three engageable portions 320 are equidistantly disposed around the engageable hole 310. The three engageable portions 320 are trapezoids and expand outwardly. Each of the three engageable portions 320 has two bevels 3201 on both sides. The three engageable portions 320 are respectively corresponding to the two engageable grooves 240, and the three engageable portions 320 are detachably engaged with the two engageable grooves 240, respectively. In addition, the two bevels 4201 are tightly connected to the two bevels 2301 during rotation so as to enhance the stability of positioning between the rotary seat 200 and the impact member 300, therefore the impact member 300 can be sleeved on and rotated by the rotary seat 200. Accordingly, the eccentric rotary fastening device 100c of the present disclosure uses the engageable connection to increase the energy of eccentric rotation so as to generate greater torque for tightening operation.

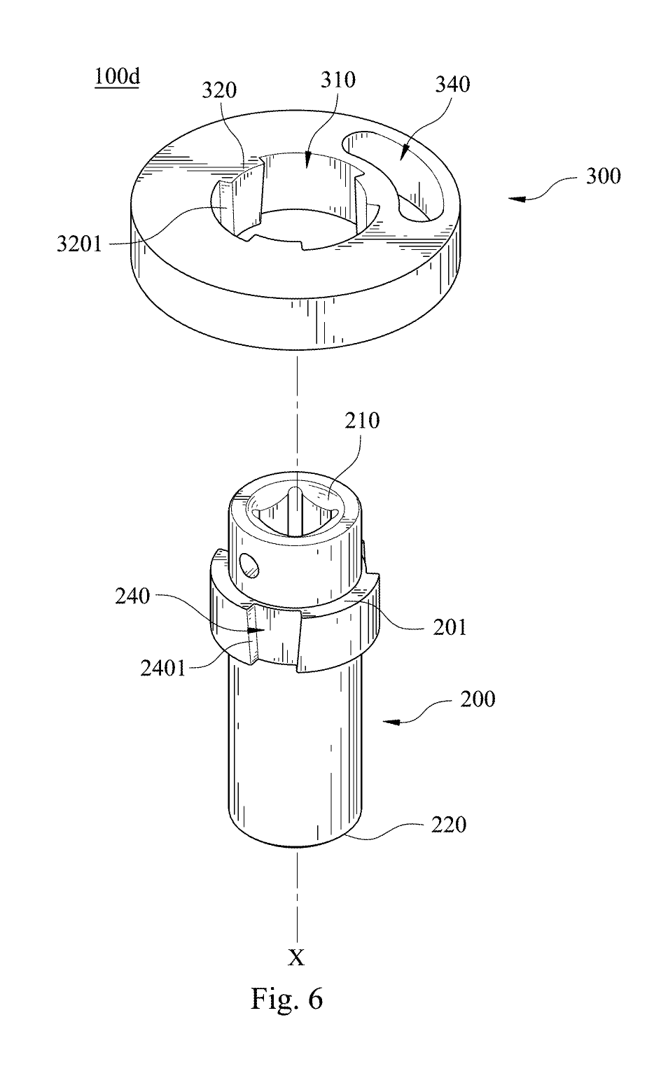

FIG. 6 shows an exploded view of an eccentric rotary fastening device 100d according to a fifth embodiment of the present disclosure. The eccentric rotary fastening device 100d includes a rotary seat 200 and an impact member 300. The impact member 300 includes an engageable hole 310, three engageable portions 320 and a hollow portion 340. In FIG. 6, the detail of the rotary seat 200, the engageable hole 310 and three engageable portions 320 is the same as the embodiments of FIG. 5, and will not be described again herein. In FIG. 6, the impact member 300 further includes the hollow portion 340 having an arc shape. The hollow portion 340 is configured to offset the center of gravity G of the impact member 300 from the rotational axis X to an opposite side of the hollow portion 340. The hollow portion 340 can have an elliptical shape, a circular shape, a triangular shape, a quadrangular shape or a polygonal shape. The size and number of the hollow portion 340 may be determined by the manufacturer. The impact member 300 of the eccentric rotary fastening device 100d has a complete circular shape to be more aesthetically pleasing. In addition, the impact member 300 of the present disclosure allows the user to smoothly and conveniently conduct a hand-held operation during tightening or loosening.

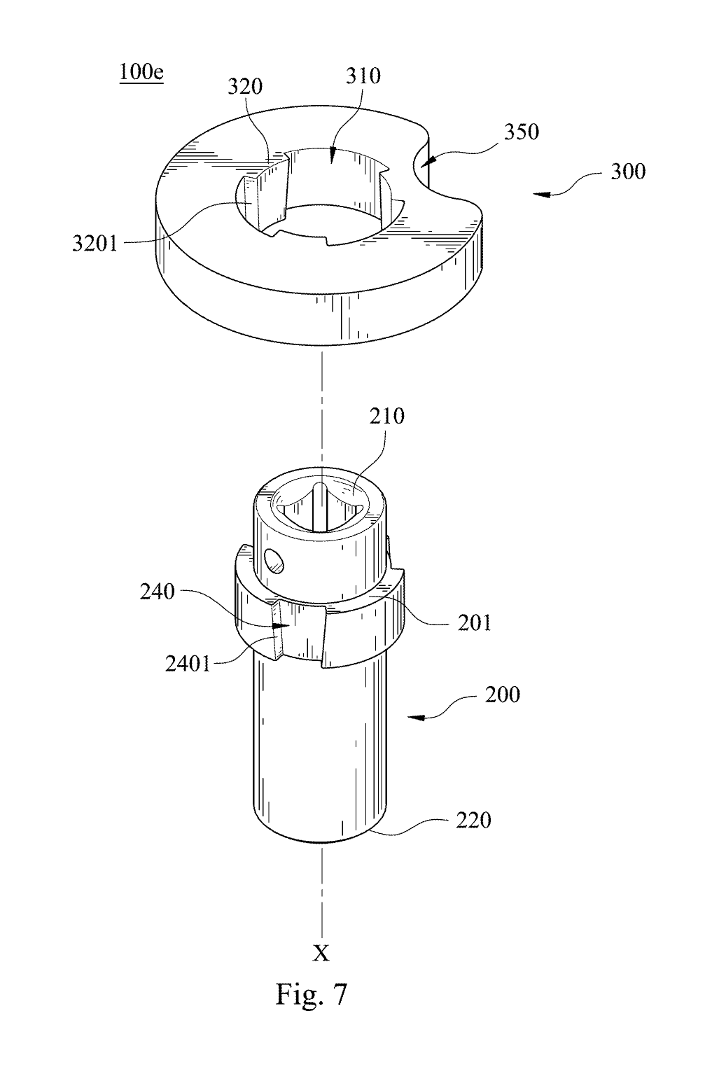

FIG. 7 shows an exploded view of an eccentric rotary fastening device 100e according to a sixth embodiment of the present disclosure. The eccentric rotary fastening device 100e includes a rotary seat 200 and an impact member 300. The impact member 300 includes an engageable hole 310, three engageable portions 320 and a recess 350. In FIG. 7, the detail of the rotary seat 200, the engageable hole 310 and three engageable portions 320 is the same as the embodiments of FIG. 5, and will not be described again herein. In FIG. 7, the impact member 300 further includes the recess 350 which is configured to offset the center of gravity G from the rotational axis X to an opposite side of the recess 350. Certainly, the shape, size and number of the recess 350 may be determined by the manufacturer. The manufacturing process of the eccentric rotary fastening device 100e is simple and inexpensive, so that it is suitable for mass production.

When each of the eccentric rotary fastening devices 100, 100a, 100b, 100c, 100d, 100e rotates along a first rotating direction (e.g., a tightening direction), the impact member 300 can provide an obverse torque to enhance the tightening. On the contrary, when each of the eccentric rotary fastening devices 100, 100a, 100b, 100c, 100d, 100e rotates along a second rotating direction (e.g., a loosening direction), the impact member 300 also provides a reverse torque to enhance the loosening by inertia. Therefore, the eccentric rotary fastening device 100, 100a, 100b, 100c, 100d, 100e of the present disclosure are also suitable to loosen the screws or the nuts that froze up with rust.

In FIGS. 1-2B, 5, 6 and 7, the rotary seat 200 may be integrally connected to the impact member 300. In FIGS. 3A and 3B, the rotary seat 200 may be integrally connected to the impact members 300a, 300b. The integral connection not only ensures that the rotary seat 200 and the corresponding impact members 300, 300a, 300b are not separated by vibration or rotation, but also reduces the dangerous instability and the risk of an offset of the center of gravity G and separation.

In FIGS. 2A, 4A, 5, 6 and 7, the number of the impact members 300 may be plural. The impact members 300 and the driving end 210 may be spaced by a plurality of driving distances (not shown), respectively, and the driving distances are different from each other. In other words, the impact members 300 are located at different positions along the rotational axis X. For the same reason, in FIG. 3A, the impact members 300a, 300b and the driving end 210 can also be spaced by different driving distances. Therefore, the impact members 300 of the present disclosure can selectively change the center of gravity of each of the eccentric rotary fastening devices 100, 100a, 100b, 100c, 100d, 100e by different driving distances and flexibly adjust the effect of rotation, thereby conducting non-uniform disposition and eccentric rotation.

When the number of the impact members 300 is greater than one (e.g., two impact members 300a, 300b in FIG. 3A), the rotary seat 200 is integrally connected to one of the impact members 300a, and is detachably connected to another of the impact members 300b. Hence, the different connection between each impact member 300 and the rotary seat 200 can be performed according to user's preferences so as to satisfy various requirements of different applications.

According to the aforementioned embodiments and examples, the advantages of the present disclosure are described as follows.

1. The structure of the eccentric rotary fastening device of the present disclosure can provide an extra impact torque by an eccentric rotation and convenient hand carrying or hand-held operation so as to solve the problems of insufficient rotational torque of a conventional rotary fastening device.

2. The eccentric rotary fastening device of the present disclosure utilizes a detachable structure between the rotary seat and the impact member to increase the flexibility of the operation. Additionally, the simple detachable structure can not only save the user's physical strength, but also reduce the assembly and disassembly time, thereby increasing the efficiency of the operation.

3. The impact members of the present disclosure can selectively change the center of gravity of the eccentric rotary fastening device by different driving distances and flexibly adjust the effect of rotation, thereby conducting non-uniform disposition and eccentric rotation.

4. The special structure of the impact member of the present disclosure can reduce the air resistance of the rotating so as to effectively and completely transmit the rotational torque.

5. The impact member of the present disclosure allows the user to smoothly and conveniently conduct a hand-held operation during tightening or loosening.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An eccentric rotary fastening device disposed between a driving tool and a rotated member, the eccentric rotary fastening device comprising:
a rotary seat rotated around a rotational axis, wherein the rotary seat has a driving end and a tightening end, the driving end is detachably connected to the driving tool, and the tightening end is detachably connected to the rotated member; and
at least one impact member having a center of gravity and connected to an exterior of the rotary seat, wherein there is a distance between the center of gravity and the rotational axis.

2. The eccentric rotary fastening device of claim 1, wherein the rotary seat is integrally connected to the impact member.

3. The eccentric rotary fastening device of claim 1, wherein the rotary seat is detachably connected to the impact member.

4. The eccentric rotary fastening device of claim 3, wherein,
the rotary seat comprises at least two engageable grooves disposed around the rotational axis; and
the impact member comprises at least two engageable portions respectively corresponding to the two engageable grooves, and the two engageable portions are detachably engaged with the two engageable grooves, respectively.

5. The eccentric rotary fastening device of claim 3, wherein,
the rotary seat comprises a concave groove having an internal thread; and
the impact member comprises a convex portion having an external thread corresponding to the internal thread, and the external thread is correspondingly screwed into the internal thread.

6. An eccentric rotary fastening device disposed between a driving tool and a rotated member, the eccentric rotary fastening device comprising:
a rotary seat rotated around a rotational axis, wherein the rotary seat has a driving end and a tightening end, the driving end is detachably connected to the driving tool, and the tightening end is detachably connected to the rotated member; and
an impact member having a center of gravity and detachably connected to an exterior of the rotary seat, wherein the impact member comprises a convex gravity portion which is outwardly extended from the impact member, the convex gravity portion is rotated around the rotational axis by the rotary seat to generate a tangential impact force, the center of gravity is corresponding to the convex gravity portion, and there is a distance between the center of gravity and the rotational axis.

7. The eccentric rotary fastening device of claim 6, wherein,
the rotary seat comprises at least two engageable grooves disposed around the rotational axis; and
the impact member comprises at least two engageable portions respectively corresponding to the two engageable grooves, and the two engageable portions are detachably engaged with the two engageable grooves, respectively.

8. An eccentric rotary fastening device disposed between a driving tool and a rotated member, the eccentric rotary fastening device comprising:
a rotary seat rotated around a rotational axis, wherein the rotary seat has a driving end and a tightening end, the driving end is detachably connected to the driving tool, and the tightening end is detachably connected to the rotated member; and
a plurality of impact members connected to an exterior of the rotary seat, wherein each of the impact members has a center of gravity, the centers of gravity of the impact members are integrated to form a combined center of gravity, and there is a distance between the combined center of gravity and the rotational axis.

9. The eccentric rotary fastening device of claim 8, wherein,
the rotary seat comprises a plurality of concave grooves, and each of the concave grooves has an internal thread; and
each of the impact members comprises a convex portion having an external thread corresponding to the internal thread, and the external thread is correspondingly screwed into the internal thread.

10. The eccentric rotary fastening device of claim 8, wherein the impact members and the driving end are spaced by a plurality of driving distances, respectively, and the driving distances are different from each other.

11. The eccentric rotary fastening device of claim 8, wherein the rotary seat is integrally connected to the impact members.

12. The eccentric rotary fastening device of claim 8, wherein the rotary seat is integrally connected to one of the impact members, and is detachably connected to another of the impact members.
